(19) United States
(12) Patent Application Publication
(10) Pub. No.: US 2017/0059528 A1
(43) Pub. Date: Mar. 2, 2017

(54) MULTI ULTRASONIC PROBE FOR SCANNING WELDED ZONE OF TUBE

(71) Applicant: ENESG CO., LTD., Daejeon (KR)

(72) Inventors: Un Hak SEONG, Gyeongsangnam-do (KR); Sung Woo RYU, Daejeon (KR); Won Il KIM, Busan (KR); Su Jin BAE, Daejeon (KR); Byeong Lae CHO, Seoul (KR); Jong Bum WON, Daejeon (KR)

(21) Appl. No.: 15/212,012

(22) Filed: Jul. 15, 2016

(30) Foreign Application Priority Data
Aug. 25, 2015 (KR) 10-2015-0119873

(51) Int. Cl. G01N 29/04; G01N 29/36; G01N 29/265

(52) U.S. Cl. CPC G01N 29/041; G01N 29/265; G01N 29/36; G01N 2291/267; G01N 2291/106

(57) ABSTRACT

Provided is to ultrasonic probe used in scanning defect of welded zone of tube, the ultrasonic probe includes a probe body having a predetermined length, a connection bar connected to one end of the probe body, a phased array ultrasonic sensor installed on one side surface of the probe body to scan positions and shapes of the defects, and a pair of time of flight diffraction (TOFD) sensors respectively installed in the same line with the phased array ultrasonic sensor therebetween to scan depths of the defects. The present invention having the above-described configurations may significantly reduce a time taken to scan and accurately scan the positions, the shapes, and the depths of the defects.

### CROSS-REFERENCE TO RELATED APPLICATION

This application claims priority to Korean Patent Application No. 10-2015-0119873 filed on Aug. 25, 2015 and all the benefits accruing therefrom under 35 U.S.C. 119, the contents of which are incorporated b reference in their entirety.

### BACKGROUND OF THE INVENTION

The present invention relates a multi ultrasonic probe for scanning a welded zone of a tube, and more particularly to, a multi ultrasonic probe for scanning a welded zone of a tube, which is capable of accurately detecting positions and depths of defects such as cracking or corrosion in the welded zone of a small-diameter tube such as an electric heater sleeve of a pressurizer, a nozzle for drain/measurement of a steam generator, or a nozzle for installing as resistance temperature detector (RTD) of a hot leg/cold leg of a reactor coolant system (RCS) in a pressurized water reactor type nuclear power plant.

A pressurized water reactor type nuclear power plants absorb energy generated during a fission process of nuclear fuels to generate steam and then rotate a turbine by using the steam to produce electricity. For this, a nuclear steam supply system NSSS (or primary-side), which are constituted by a nuclear reactor, a pressurizer, a steam generator, and a coolant circulation pump, are installed in a containment building of a nuclear power plant. Here, a plurality of electric heaters are installed through a sleeve by welding to pressurize coolant at a predetermined pressure or more while the coolant is circulated and heated in the primary-side in the lower portion of the pressurizer. Also, a plurality of nozzles, which are constituted by small-diameter tubes, are installed by welding to install a plurality of resistance temperature detectors (RTDs) for measuring, a temperature of the coolant in a hot leg/cold leg of a reactor coolant system (RCS). Also, a plurality of nozzles for dram/measurement are installed in the steam generator by welding.

However, the pressurizer and the hot leg/cold leg are made of an Inconel or Alloy 600 material so as to improve corrosion resistance. Thus, when the electric heater sleeve or the nozzles for installing the RIDs are installed in the pressurizer or the hot leg/cold leg, which is mode of the foregoing material, by the welding, it is reported that stress corrosion cracking (SCC) occur at the welded portion. Also, if the cracking advances, a loss of coolant accident (LOCA) may occur.

Thus, in the nuclear power plant, a nondestructive scanner such as ultrasonic scanning device is used to evaluate integrity of the welded zone, thereby preventing the loss accidents of the coolant, which occur by the cracking due to the stress corrosion in advance when the nuclear fuel is exchanged. The ultrasonic scanning device for the welded zone of the tubes generally includes a scanner body, a fixing unit, a transfer and rotation unit, a probe connection unit, and an ultrasonic probe. When scanning by using the ultrasonic scanning device to determine whether defects such as cracking occur in the welded zone of the tubes, the scanner body is firmly fixed first to the tube that is an object to be scanned. Then, in a state where the ultrasonic probe, in which an ultrasonic generator (or a sensor) is installed, is inserted into the tube or installed outside the tube, while the ultrasonic probe is transferred and rotated in a longitudinal direction of the tube by using the transfer and rotation unit, whether the defects of the welded zone of the tube, what size the defects have, and which zone the defects exist may be inspected.

However, as illustrated in FIG. 1, in an ultrasonic probe according to the related art, three pulse-echo (PE) type ultrasonic sensors are installed at both sides in a longitudinal direction of the ultrasonic probe. Here, each of the ultrasonic sensors is installed at an angle of about 0°, about 45°, and about 135° with respect to a horizontal axis to scan an entire welded zone. When the ultrasonic scanning is performed, the ultrasonic probe having the above-described structure is installed outside or inside the tube and then moves upward and downward in the longitudinal direction of the tube and rotates an angle of about 360° to inspect whether the defects exist, and positions, depths, and shapes of the defects. As described above, when the ultrasonic probe is constituted by only the plurality of PE type ultrasonic sensors, defects that exist in an surface between the welded zone and the basic material may be relatively accurately and easily scanned due to detection characteristics of the PE type ultrasonic sensors. However, it is difficult to accurately scan the defects which exist in the inside of the welded zone and the depths of the defects.

### PRIOR ART DOCUMENTS

### Patent Documents

(Paten Document 1) KR 10-0802315 131

(Paten Document 2) KR 10-2000-0064549 A

(Paten Document 3) KR 10-2001-0076629 A

(Patent Document 4) 3P2003-57219 A

### SUMMARY OF INVENTION

To solve the foregoing limitations in the ultrasonic probe for scanning the welded zone of the tube according to the related art, the present invention is to provide a multi ultrasonic probe for scanning a welded zone of a tube, which is capable of accurately detecting positions, shapes, and depths of defects of the tube through one scanning to significantly reduce a time taken to perform the ultrasonic scanning and improve accuracy and reliability in results obtained through the ultrasonic scanning.

An object of the present invention is to provide an ultrasonic probe including: a probe body having a predetermined length; a connection bar connected to one end of the probe body; a phased array ultrasonic sensor installed on one side surface of the probe body to scan positions and shapes of the defects; and a pair of time of flight diffraction (TOFD) sensors respectively installed in the same line with the phased array ultrasonic sensor therebetween to scan depths of the defects.

Two pairs of pulse-echo type ultrasonic sensors may be installed on a surface opposite to the surface on which the phased ultrasonic sensor and the TOFD sensors are installed.

One TOFD sensor of the pair of TOFD sensors may function as an ultrasonic sensor for transmitting a signal, and the other TOFD sensor may function as an ultrasonic sensor for receiving a signal.

The pair of TOFD sensors may be inclinedly arranged at predetermined angles to face each other.

### BRIEF DESCRIPTION OF THE DRAWINGS

Exemplary embodiments can be understood in more detail from the following description taken in conjunction with the accompanying drawings, in which:

FIG. 1 is a view illustrating an example of an ultrasonic probe for scanning a welding zone of as tube according to the related art;

FIG. 2 is a view illustrating an example of a multi ultrasonic probe for scanning a welded zone of a tube according to an embodiment of the present invention; and

FIG. 3 is a view illustrating an example of a use of the multi ultrasonic probe for scanning the welded zone of the tube according to an embodiment of the present invention.

### DETAILED DESCRIPTION OF EMBODIMENTS

Hereinafter, the constitutions and operations of the present invention will be described in detail with reference to the accompanying drawings according to a preferred embodiment.

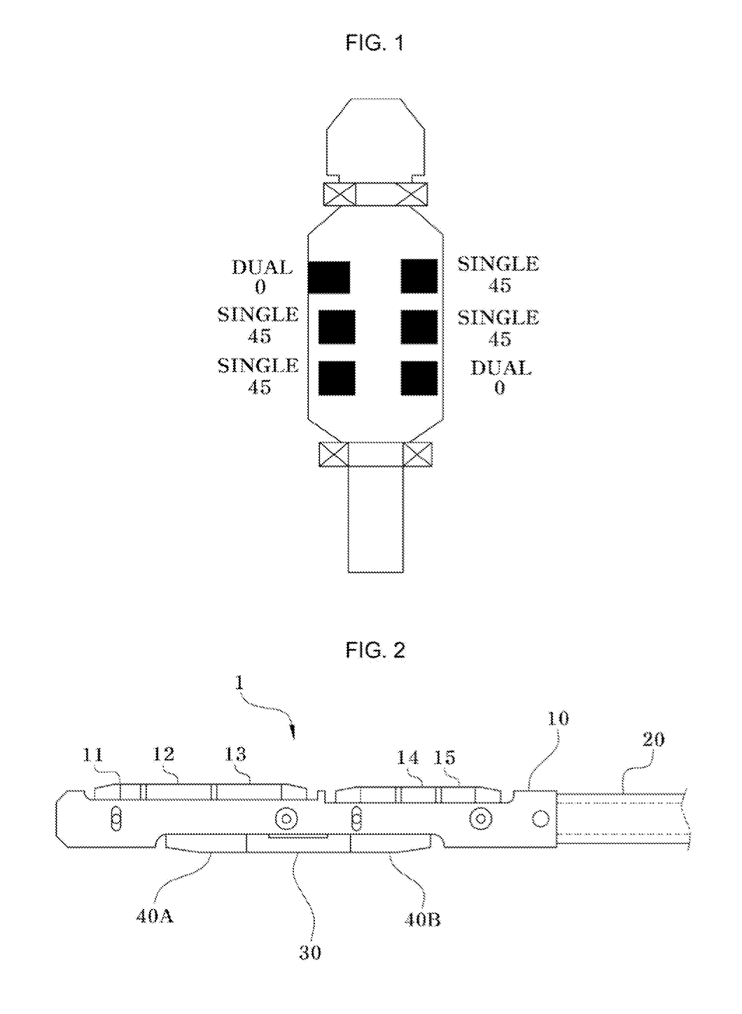

The present invention relates a multi ultrasonic probe for scanning a welded zone of a tube, which is capable of quickly accurately scanning defects of the welded zone of the small-diameter tube such as a nozzle for installing a resistance temperature detector (RTD). As illustrated in FIG. 2, the ultrasonic probe 1 according to the present invention includes a probe body 10, a connection bar 20, a phased array ultrasonic. sensor 30, and time of flight diffraction (TOFD) sensors 40A and 40B.

The probe body 10 functions as a frame for installing and supporting each of ultrasonic sensors on both side surfaces thereof. For this, the probe body 10 is provided as a metal plate or metal rod that is made of an anti-corrosive material such as stainless steel. A pair of grooves are defined in one surface of the probe body 10 to attach a pair of pulse-echo type ultrasonic sensors to the grooves, and a groove is defined in an opposite surface to install the phased array ultrasonic sensor and a pair of TOFD sensors 40A and 40B in the groove. The probe body 10 has one end connected to the connection bar 20 that will be described later.

The probe body 10 has the one end on which the connection bar 20 is installed so that the ultrasonic probe 1 is installed and moved inside or outside the small-diameter tube such as the nozzle for installing the RTD. For this, the connection bar 20 has a bar or rod shape having a predetermined, length so that the connection bar 20 may be transferred in a longitudinal direction of the tube. Also, the connection bar 20 is formed of a metallic material such as stainless steel to realize rigidity and anti-corrosive characteristics.

Also, the connection bar 20 has a through hole (not shown) in a longitudinal direction thereof. A cable for transmitting and receiving power and a signal to/from each of the ultrasonic sensors installed on the probe body 10 through the through-hole is inserted and then connected to a main body of the ultrasonic scanning device.

The phased array ultrasonic sensor 30 is seated and installed on a central portion of the groove defined in one of both side surfaces of the probe body 10 to accurately scan positions and shapes of defects of the welded zone of the tube that is an object to be scanned (hereinafter, referred to as a target tube). The phased array ultrasonic sensor 30 is constituted by a plurality of ultrasonic sensors that are arranged to have phases different from each other. Since the phased array ultrasonic sensor 30 are controlled to have amplitudes and phases different from each other for each sensor, the ultrasonic signal may be freely set in range of an irradiation angle and focusing distance. Thus, the phased array ultrasonic sensor may cover a wide range at once and be freely set in range of the irradiation. In addition, a time taken to analyze the received ultrasonic signal may be reduced.

However, when the phased array ultrasonic sensor 30 is used for scanning the defects of the welded zone, although whether the defects exist, the positions and shapes of the defects are relatively accurately inspected, it is difficult to accurately scan the depths of the defects. Thus, according to the present invention, the phased array ultrasonic sensor 30 may be used for inspecting whether the defects exist in the welded zone of the tube and the positions and shapes of defects, and the time of flight diffraction (TOFD) sensors 40A and 40B may be used for scanning the depths of defects.

Thus, according to the present invention, the TOFD sensors 40A and 40B are respectively installed on the left and right sides of the phased array ultrasonic sensor 30, which is installed on the central portion of the groove defined in the longitudinal direction of the probe body 10, with the phased array ultrasonic sensor 30 they between. When the defects exist in the welded zone, the TOFD sensors 40A and 40B may measure the depths of defects by using diffraction characteristics of the ultrasonic signal at the detective portions. For this, according to the present invention, one TOFD sensor 40A may function as a sensor for transmitting the ultrasonic signal, and the other TOFD sensor 40B may function as a sensor for receiving the ultrasonic signal. When the TOFD sensor 40A for transmitting a signal and the TOFD sensor 40B for receiving a signal are inclinedly arranged at predetermined angles to face each other, the ultrasonic signal emitted from the TOFD sensor 40A for transmitting a signal reaches a surface of the target tube and is reflected. Then, the ultrasonic signal is incident and received into the TOFD sensor 40B. In this process, when the defects such as the cracking exist in the welded zone, the ultrasonic signal emitted from the TOFD sensor 40A may not teach the surface of the target tube. The ultrasonic signal may be diffracted at the defect portions and received to the TOFD sensor 40B. As a result, a difference between flight times of the ultrasonic signals may occur according to whether the defects exist. Therefore, the depths of the defects may be accurately measured by analyzing the difference.

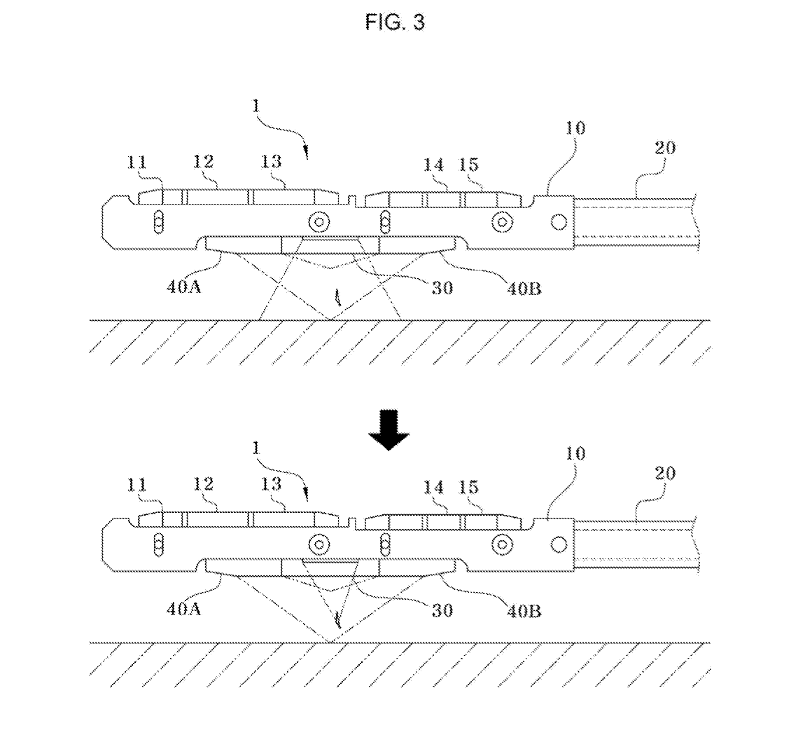

Also, as illustrated in FIG. 3, each of pairs of PE type ultrasonic sensors 12, 13, 14, and 15 is installed to the pair of grooves defined in the opposite surface facing the surface of the probe body 10, on which the phased array ultrasonic sensor 30 and the TOFD sensors 40A and 40B are installed. One ultrasonic sensor 12 is installed in the groove defined in the left side (or the right side) to emit an ultrasonic signal at an angle of about 45° in an upward direction, and the other ultrasonic sensor 13 is installed to emit an ultrasonic signal at an angle of about 45° in a downward direction. Also, one ultrasonic sensor 14 is installed in the groove defined in the right side (or the left side) to emit an ultrasonic signal at an angle of about 45° in a right direction, and the other ultrasonic sensor 15 is installed to emit an ultrasonic signal at an angle of about 45° in a left direction. The interface between the welded zone and the basic material may he inspected at once by the arrangement of the PE type ultrasonic sensors.

Alternatively, an eddy current sensor 11 may be further provided outside at least one of the PE type ultrasonic sensor 12 and 14 to confirm whether defects exist in a surface of the base material. The eddy current sensor 11 applies high frequency current to a cod to generate eddy current in the surface of the target tube, thereby analyzing a distribution state of the eddy current and determining whether the defects exist. Since a method for inspecting whether the defects exist on the surface by using the eddy current sensor 14 is well known, its detailed description will be omitted.

Hereinafter, a method for inspecting defects in a welded zone of a target tube, particularly, defects in a welded zone of a nozzle for installing an RTD by using the foregoing ultrasonic probe 1 according to the present invention will be described.

When the welded zone of the nozzle for installing the RTD is scanned by using the ultrasonic probe according to the present invention, the welded zone may be scanned by using a phased array ultrasonic sensor 30 and a pair of TOFD sensors 40A and 40B. The scanning may be performed (in a mode 1) by individually using the phased array ultrasonic sensor 30 and the pair of TOFD sensors 40A and 40B. Alternatively, the scanning may be performed (in a mode 2) by simultaneously using the phased array ultrasonic sensor 30 and the pair of TOFD sensors 40A and 40B (mode 2). Hereinafter, the modes will be described according to embodiments, respectively.

### (1) Embodiment 1 (Mode 1)

Embodiment 1 relates to a process in which a phased array ultrasonic sensor 30 and a pair of TOFD sensors 40A and 40B are individually used to perform scanning. In the mode 1, a probe body 10 is connected first to the outside of a welded zone of a target nozzle (a target tube), and then power is applied to the phased array ultrasonic sensor 30 to scan positions and shapes of defects. Thereafter, the phased array ultrasonic sensor 40 is turned off, and then power is applied to each of the pair of TOFD sensors 40A and 40B to scan depths of the defects. When the scanning is performed by individually using the phased array sensor 30 and the pair of TOFD sensors 40A and 40B, the analysis of each of the ultrasonic signals may have a difficulty due to mixing of the ultrasonic signals. However, since the signals received to the TOED sensors 40A and 40B are relatively weak, it is difficult to receive a signal generated by a fine defect.

### (2) Embodiment 2 (Mode 2)

Embodiment 2 relates to a process in which a phased array ultrasonic sensor 30 and a pair of TOFD sensors 40A and 40B are used together with each other to perform scanning. Embodiment 2 is same as Embodiment 1 except that power is applied to all of the phased array ultrasonic sensor 30 and the pair of TOFD sensors 40A and 40B to perform the scanning. As described above, when the scanning is performed by simultaneously using the phased array sensor 30 and the pair of TOFD sensors 40A and 40B, a signal emitted from the phases array ultrasonic sensor 30 may be focused to convert the signal having high energy into a diffracted signal. Thus, the ‘weak signal’ of the phased array ultrasonic sensor 30 may be compensated to easily scan fine defects. Thus, Embodiment 2 may be mainly used for intensively scanning a portion in which an occurrence of defects is predicted.

As described above, according to the present invention, the phased array ultrasonic sensor and the pair of TOFD sensors may be multiply arranged on the probe body to scan the defects of the weld zone, thereby significantly reducing the time taken to scan the defects and accurately scan the positions, the shapes, and the depths of the defects.

Since the phased array ultrasonic sensor and the pair of time of flight diffraction (TOFD) sensors are arranged in multiple in the probe body according to the present invention to scan the welded areas at once, the time taken to perform the scanning may be significantly reduced.

Also since the phased array ultrasonic sensor and the pair of TOFD sensors are arranged together (in multiple) in the probe body according to the present invention, the positions, the shapes, and the depths of the defects may be accurately scanned at the sane time.

1. A multi ultrasonic probe for scanning a welded zone of a tube, which is used for scanning, defects of the welded zone of the tube, a multi ultrasonic probe comprising:
a probe body having a predetermined length;
a connection bar connected to one end of the probe body;
a phased array ultrasonic sensor installed on one side surface of the probe body to scan positions and shapes of the defects; and
a pair of time of flight diffraction (TOFD) sensors respectively installed in the same line with the phased array ultrasonic sensor therebetween to scan depths of the defects.

2. The multi ultrasonic probe of claim 1, wherein two pairs of pulse-echo type ultrasonic sensors are installed on a surface opposite to the surface on which the phased ultrasonic sensor and the TOFD sensors are installed.

3. The multi ultrasonic probe of claim 1, wherein one TOFD sensor of the pair of TOFD sensors functions as an ultrasonic sensor for transmitting a signal. and the other TOFD sensor functions as an ultrasonic sensor for receiving a signal.

4. The multi ultrasonic probe of claim 3, wherein the pair of TOFD sensors are inclinedly arranged at predetermined angles to face each other.
